(19) United States
(12) Patent Application Publication
(10) Pub. No.: US 2026/0191152 A1
(43) Pub. Date: Jul. 9, 2026

(54) Triple-Lock Border Edge and Retain Barrier Apparatus

(71) Applicants: Max Ryan Peters, Springfield, MO (US); Luke Alden Peters, Springfield, MO (US)

(72) Inventors: Max Ryan Peters, Springfield, MO (US); Luke Alden Peters, Springfield, MO (US)

(21) Appl. No.: 19/010,160

(22) Filed: Jan. 5, 2025

(51) Int. Cl. A01G 9/28

(52) U.S. Cl. CPC A01G 9/28

(57) ABSTRACT

The present invention is a border edge and retain barrier and curb apparatus for the creation and maintenance of beds, rings, patios and other spaces in landscapes. Border barrier members interconnect through engagement of overlapping base flanges (FIGS. 1-4), wall flanges (FIGS. 1-8), slots, tabs, lock pin holes (FIGS. 1-11) and lock pins (FIGS. 1-12) creating solid, seamless elongate horizontal base and vertical wall surfaces that span barrier member assemblies of solid construction with no cavities, voids or hollow channels. Barrier members are assembled in a plurality of geometric shapes all providing solid horizontal surface on both sides of the solid vertical surface and may be nested creating integrated curbs. The resulting assembly is freestanding, self-connected requiring no external anchors, connectors, or braces. This present invention quickly and easily retains soil, mulch, gravel, pavers, concrete and other materials to separate and edge lawns, beds, trees, patios, decks and other landscaping.

### BACKGROUND OF THE INVENTION

The invention disclosure herein pertains to the field of landscaping and the creation and maintenance of secure boundaries that locate, position, contain and separate elements within a lawn, garden, or landscape. This invention is for an apparatus consisting of a plurality of barrier members manufactured with specific characteristics and features that in combination function uniquely to establish an interlocking connection which enables creation of unique border edge and retain barrier assemblies. This invention simplifies the creation of these landscape elements and eases the maintenance and upkeep over time. This invention pertains to an apparatus that is assembled and installed as a system of uniquely interconnected, interdependent barrier members forming landscape artifacts of various function including: beds; tree rings; mailbox surrounds; patios; decks; in situ concrete curbs, sidewalks, steppingstone paths; retaining walls; and other uses.

This invention as disclosed relates to more than one of the Patent classification definitions. The Cooperative Patent Classification system specifies A01G 13/00 as Protecting Plants and A01G 9/00 as including Edging for beds, lawn or the like. In addition, E01C 11/222 includes Raised Kerb/Curbs and E01C 19/00 includes devices for preparing paving materials, and E02D 29/00 includes gabion and retaining walls. This invention has application in all these classifications however the primary embodiment is in creating landscape elements therefore the Field of Application for this innovation is A01G 9/28 described as Edging for beds, lawns, e.g. using tiles.

There have been many attempts to develop products that address the challenges of a simple, effective border edging and barrier system. A survey of prior art and products currently on the market exposes many shortcomings. As an example, U.S. Pat. No. 4,934,093 June 1990 Yanna 47/33 claims edging with a horizontal base member with a perpendicular raised wall and flanges on each side. Said members were defined in both straight and arcuate shapes and can be configured to be placed in an abutting relationship with another of said member. Furthermore, this patent describes the horizontal base as an annulus configured to be placed around said plant life, defining a central opening. This design is inadequate in a few key areas. First, the invention as described in a solid version, identifies a break to enable positioning. Said break confirms an opening or seam in the base and wall that plants or soil can penetrate. This is typical of many concrete or solid edging products in which the prior art focuses on the cross-sectional shape of the edging but does not give sufficient consideration to the connection between units. The connection between multiple units is often a simple abutment of a single surface which results in a break or seam which is a typical point of failure. Furthermore, there is no mention of a means to establish a solid connection between multiple units so this would be subject to being pushed out of position or spreading out due to freeze thaw cycles or traffic on the beds. Partial burial of the border or edging is mentioned and that may help keep it positioned. However, that would not address the seam or break. This design has multiple gaps leaving an unsatisfactory solution. This patent also claims a hollow version of this design which could potentially enable a simple overlap of two meeting units. Simply stacking or overlapping on one dimension of adjacent members is equally inadequate. First, hollow edging is prone to being crushed or flattened. Second, hollow overlapping borders are easily pushed out of position. Any pressure on the bedding or mulch will push against the edging causing it to spread. Additional anchoring would be required, all of which renders this an inadequate design.

Another example of prior art limitations is on U.S. Pat. No. 5,157,867 October 1992 Fritch 47/33: which established a landscape edging strip impenetrable by grass for separating a mowed lawn area from an un-mowable area. This elongated strip comprises an upstanding retainer portion intermediate and integral with a mowing strip and an anchoring strip. There are multiple limitations of this patent. This patent specifies an anchor strip to be used to secure the edging to the ground or substrate. Attachment to the ground introduces problems due to freeze-thaw cycles and limits deployment on hard surfaces. This design also specifies hollow cross sections of various shapes, so units are subject to being crushed by a landscaper or a heavy pet. Multiple units require connectors that insert into the hollow cavities or slide over the ends of adjacent units both of which is a limitation. Another limitation is the need to use connectors or web for the solid horizontal surface.

Another example of prior art limitations is from U.S. Pat. No. 6,505,819 January 2003 Damon 256/1 which established an improved barrier for the bottom of fences, foundations, or other structures. It comprises elongated members that are placed under fencing longitudinally and with an optional vertical riser. This patent is limited in the requirement to connect to fences or other structures to keep it in position. It is not freestanding, self-connecting. Segments have a basic overlap that does not interlock to adjacent members to prevent movement or separation. The joints do not lock together and are not secure on all three dimensions.

Another example of prior art issues is U.S. Pat. No. 9,719,273 August 2017 Raab E04H 17/063. This established a vegetation barrier for use beneath a fence to inhibit the growth of vegetation. It comprises elongated barrier members and intermediate members each of which may include risers. This employs elongated openings in the horizontal barrier for securement pins or ground screws to pass through and into underlying surface. This also defines a single slot at the base of the riser to engage an intermediate member. The flaws of this patent include: a requirement to connect to fences; barrier members are secured by connecting to the underlying surface; the slot employed only works in one dimension to prevent updown movement, it does not prevent sideways movement or separation. The joints do not lock together and are not secure across three dimensions thus it requires stakes or anchors. The resulting apparatus is not free standing, self-supporting as required for tree surrounds, beds and other applications.

Another example of prior art shortcomings is with U.S. Pat. No. 4,863,307 September 1989 Jones. This established a Restraint Edge for Paving Members. It comprises vertical strip restraining elements for defining a boundary. It also comprises horizontal extension elements which extend out from the upright strip, as well as force converting elements. This patent has several issues. It requires being buried and it is staked or anchored to the ground. It does not provide mow over protection on the opposite side. It is one sided so does not enable pavers immediately adjacent to beds and such. Connecting multiple units appears to be through basic abutment so there is no interlock of adjacent members.

In addition, U.S. Pat. No. 5,212,917 May 1993 Kurtz established a Brick Edging Device. It comprises an elongate strip extending longitudinal having a flange portion attached to an edge of the strip extending in a transverse direction outwardly from one side of the strip. The flange has a series of V-shaped cut-out portions spaced along the length. The strip is buried to abut soil on one side and on opposite side the brick sets atop the flanges which are attached to the substrate using stakes. This patent has several issues. It requires digging out the area for the bricks it is staked or anchored to the ground. It does not provide mow over protection. It is one sided so does not enable pavers immediately adjacent to beds and such. This patent does not provide mow over protection on either side.

In summary, there are multiple shortcomings of prior art including: 1) the connection between various members. Prior art is not self-connecting. It requires connectors or provides for a simple overlap or uses a web or underlayment. No prior art engineers the connectivity into each member for a self-connecting feature that provides secure interconnection across all three dimensions preventing movement on the x, y or z axis. Edging is often bumped by pets, children, during lawn maintenance, and even extreme weather. The members can be caused to shift out of position if not locked into place. 2) Border barrier edging that requires stakes to secure into the substrate/subsurface. 3) Edging that is hollow or concave. Edging will be stepped on and knocked around so being of solid construction is critical. 4) Edging that is not solid and can be mowed over on both sides. 5) Edging system that cannot be adapted to different shapes—straight, square, arcuate and any combination thereof and still provide solid horizontal surface on both sides of the vertical surface. 6) Edging that must be buried in the ground is labor intensive and subject to freeze thaw cycle dislodging. 7) Edging of lightweight material that is not adequate to retain soil, mulch, gravel, stone, pavers or concrete. These surfaces will be walked on which can create significant spread force. 8) Edging that requires attachment to fencing or a wall to remain upright and prevent penetration of soil, mulch, or vegetation. 9) Edging that cannot be upgraded in place with additional members to be filled with concrete, stone, or pavers to create professional results.

The object of this invention is to overcome the limitations of prior art with a freestanding, self-connected triple-lock border edge and retain barrier apparatus that is easier to use and provides more utility than any previous options.

### BRIEF SUMMARY OF THE INVENTION

This present invention is a landscape border edge and retain barrier and curb apparatus for creation of secure boundaries that locate, position, contain and separate elements within a lawn, garden, or landscape. This apparatus consists of multiple interconnected, interdependent barrier members which are manufactured with specific characteristics or features to interconnect and interlock with adjacent abutted barrier members to create elongate compound assemblies in multiple various shapes that will separate and retain landscape materials and provide mow-over functionality on either side of the border edge barrier. The barrier members interlock on three dimensions which prevents movement on the x, y, or z axis. The barrier members require no stakes or anchors into underlying surface, no connections to fencing, and no connections to adjacent surfaces. Joints interlocked to secure against motion top to bottom, side to side and front to back. These interlocked barrier members are freestanding and self-connected to assemble into elongated barrier assemblies for straight, curved, or combined installations. The members of this invention are set upon the ground and interlocked to create the complete installation with no digging required. Once fully installed, the apparatus retains fill material on one or both sides, it provides mow over protection on one or both sides, and it is secure in place as an outcome of the fill material and the interlocked joints. This invention functions as tree ring, paver restraint, fence edger, landscape bed border, and leave in place concrete forms that provides retainment and mow over protection.

This invention comprises barrier members which incorporate a specific set of physical characteristics to provide the border, edge, retain functionality as well as enabling the interconnection of different members in a secure fashion described as a triple-lock which means each connection is locked in place on the x, y, and z axis by a physical connection that secures each barrier member to an adjacent, abutted barrier member. To accomplish this triple-lock barrier function, each barrier member includes a base which is generally horizontal but, in some embodiments, may be sloped or stepped. This base is relatively thin and rigid and manufactured from material substantially rigid and suitable to permanent outdoor installation. The base is typically elongate and rectangular in shape, but some barrier members may be shorter and square in nature, while others are angled or arcuate. The base is sufficiently wide so that each barrier member is free standing.

Barrier members include one or more base flanges extending from either the top or bottom of the base and from one or more of the base ends such that it will overlap with a base flange on an adjacent, abutted barrier members base flange. The base flange is typically half the height of the base so that when two base flanges overlap, they are equal in height to the base.

Barrier members include a wall which extends generally upward vertical from the base in in the preferred embodiment is centered on the base. The wall runs from the center of the base out to each base end. The wall is sufficiently wide and tall to retain landscape materials. Recent innovations in ground grids such as Geocell or binding agents such as Gravel-Lok may be used to reduce pressure against the retaining wall. Additionally, multiple assemblies can be used in a stair step fashion to create higher retaining structures.

Barrier members include a wall flange which extends from one or more wall ends and from either side of the wall such that it will overlap with a wall flange on an adjacent, abutted barrier member wall flange. The width of the wall flange is such that two overlapped wall flanges are equal in width to the wall. Each wall flange includes a lock pin hole placed in a manner to align with a similar lock pin hole on an overlapped wall flange.

Barrier members base flanges will include either a base tab or a base slot. A barrier member may include or a combination with a base flange, base tab on one base end and a base flange, base slot on the other base end. The base flange, base tab combination includes a base tab which is integral with the base flange and extends from the base end. The base tab is rectangular in shape and is somewhat shorter than the base flange and is equal in length to a base slot so that when adjacent barrier members are connected the base tab fully seats into the base slot. The base tab height is such that the base tab on top of the base flange is equal in height to the base. The base tab is intermediate the base flange and a portion of the wall flange. The base flange, base slot combination includes a base slot which extends from the base flange end inwards towards the base end and underneath a portion of the wall flange. The base slot is rectangular in shape and is equal in width to wall and to the base tab on adjacent abutted barrier member. The base slot is somewhat shorter than the base flange with length being equal to base slot on adjacent member to be abutted and interconnected upon assembly. The base slot is underneath a portion of the wall flange such that two overlapped wall flanges are above the tab and slot connection which prevents connected barrier members from vertical separation.

Barrier members include lock pin holes and lock pins as the final element to complete the interlock of adjacent, abutted members. A lock pin hole is on each wall flange and is positioned to align with additional lock pin holes on overlapped wall flanges of adjacent, abutted members. The lock pin hole is somewhat oblong and wider than the lock pin to accommodate thermal expansion and contraction. A lock pin is included to insert through lock pin holes on assembly of overlapping wall flanges. The lock pin is someone smaller in diameter than the width of the lock pin hole and the lock pin has a lock pin head that is substantially larger that the lock pin hole to provide full coverage of the lock pin hole such that the resulting wall is a solid vertical surface

The preferred embodiment is an assembly of multiple different barrier members combined to form two square beds connected with a linear border barrier. The square beds are filled with landscape materials and may be relatively small or scaled up to be relatively large. The linear border may also be short or much longer being extended with multiple additional barrier members. This assembly may be placed along the side of a house as a flower bed and patio combination with mow over protection. This could be placed beside a driveway or curb, creating three distinct beds. The size of the squares and the length of the linear border is adjustable with longer or shorter border members and additional members may be added while preserving the solid, seamless barrier. This combination of barrier members interconnected by this inventions triple-lock connection creates a solid seamless barrier assembly that is freestanding, self-connected thereby requiring no external anchors, stakes or braces. The invention allows for the assembly and installation on concrete or rock substrate as well as traditional lawns. This would allow a paver patio or resin bound gravel to be installed over an existing concrete patio and extending out onto adjacent soil surface.

In an additional embodiment the 90-degree corners are replaced with arcuate corners creating a round edge. The linear border may also be replaced with arcuate barrier members creating a curved barrier between beds. Many design options are supported that provide flexibility to create any combination of landscape spaces. This is a significant improvement over prior art.

In an additional embodiment two complete square beds are formed with one being nested within the other. These beds are nested in such a way that the vertical walls of each bed are parallel creating a channel between beds. This channel is filled with concrete to form a curb with leave in place forms that also then become mow over edging. Alternatively, the channel is filled with pavers or gravel creating a less permanent curb. This invention provides an entirely new approach to creating concrete landscape curbs and is a drastic improvement over prior art.

### BRIEF DESCRIPTION OF DRAWINGS

FIG. 1 depicts the preferred embodiment of two beds with a linear border.

FIG. 2A depicts an isometric view of Barrier Member 1.

FIG. 2B depicts an opposite side view of Barrier Member 1.

FIG. 3A depicts an isometric view of Barrier Member 2.

FIG. 3B depicts an opposite side view of Barrier Member 2.

FIG. 4A depicts an isometric view of Barrier Member AF.

FIG. 4B depicts an isometric view of Barrier Member AF with alternating wall flanges.

FIG. 5 depicts isometric views and elevation views of the Lock Pin.

FIG. 6A depicts an isometric view of Barrier Member 1 and Barrier Member 2 aligned for fitment.

FIG. 6B depicts an opposite side view of barrier members from FIG. 5A.

FIG. 7 depicts an assembled isometric view of a linear assembly of multiple barrier members of indeterminate length.

FIG. 8A depicts elevation views of the ends of Barrier Member 1 and Barrier Member 2.

FIG. 8B depicts elevation views of the ends Barrier Member 1 and Barrier Member 2 with base slope.

FIG. 9 depicts isometric views of Member 3 in different orientations.

FIG. 10 depicts isometric views of Barrier Member 3R in different orientations.

FIG. 11 depicts isometric views of Barrier Member 3 and Barrier Member 2 aligned for fitment.

FIG. 12 depicts an assembled isometric view of a square bed assembly.

FIG. 13 depicts an exploded and assembled plan view of a square bed assembly.

FIG. 14 depicts an assembled plan view of an extended rectangular bed assembly.

FIG. 15 depicts an isometric view of a square bed assembly as a tree surround.

FIG. 16 depicts cross section elevation views of square bed assemblies.

FIG. 17 depicts plan views of the of a nested bed with curb assembly.

FIG. 18 depicts plan views of nested beds with curbs filled with concrete and pavers.

FIG. 19 depicts an elevation cross section view of a nested bed assembly as a tree surround.

FIG. 20 depicts isometric views of Barrier Member B configurations.

FIG. 21 depicts isometric views of Barrier Member S.

FIG. 22 depicts isometric views of Barrier Member L1 and L2.

FIG. 23 depicts an isometric view of Barrier Member A1.

FIG. 24 depicts plan views of Barrier Member A1 and Barrier Member A2 ring assemblies.

FIG. 25 depicts plan views of Barrier Member A1 and Barrier Member A2 arcuate assemblies.

FIG. 26 depicts an assembled plan view of a multi-bed assembly.

FIG. 27 depicts an assembled plan view of a free form bed assembly.

### DETAILED DESCRIPTION OF THE INVENTION

The following details provide a more thorough understanding of this invention. The drawings illustrate the primary barrier members and this invention's specific physical characteristics which enable the barrier members to interlock together creating a solid, seamless horizontal and vertical surface that spans the complete assembly. This assembly of interconnected members is freestanding, self-connecting and self-supporting in that each member connects only to adjacent, abutted barrier members. Barrier members may be of different shape, but all incorporate this inventions same set of physical characteristics enabling the triple-lock connection and this invention's unique function.

The barrier members are preferably formed by extrusion of HDPE, similar polymers, or other materials with similar or superior characteristics. Initial production was accomplished via 3D printing, but extrusion manufacturing is likely for economies of scale. Polymers used will be of sufficient thickness to provide necessary rigidity but also sufficiently thin on the base to be mown over. Alternatively, these barrier members may be fabricated from metal and may have various coatings. The key element of this invention is in the article of manufacture where in the barrier members include a new form with a combination of unique properties that enables a new and innovative function.

The barrier members comprise the following set of physical characteristics. A planar base of varying width and length that provides a solid foundation. The base is sufficiently sized to be placed on a surface typically soil, gravel, grass, mulch, or even concrete, stone or asphalt. There is no need or requirement for staking to the underlying surface or connecting to supporting structures. A wall extends generally upwards from the base and is intermediate and parallel to the longitudinal base sides. The wall is of sufficient height, thickness and rigidity to retain soil, gravel, mulch, paver stones, and concrete. Base flanges extend from either the top or the bottom of the base ends. The base flanges of adjacent adjoining members overlap creating a solid generally horizontal surface. Two overlapped base flanges from connected barrier members are the same height as the base. Also included are wall flanges that extends from either side of the wall. Wall flanges of adjoining members overlap creating a solid vertical surface. Two overlapped wall flanges are the same width as the wall. Each base flange includes either a base tab or a base slot either of which is intermediate the base flange and wall flange. Each base flange, base tab combination overlaps and inserts into an adjacent abutted member base flange, base slot combination. With a base tab fully inserted into a base slot which is secured between overlapping wall flanges and base flanges, the barrier members are interlocked preventing any transverse or vertical movement or shifting. Also included are lock pin holes on each wall flange that align when overlapped allowing a lock pin to insert through both wall flanges locking the members together. These physical characteristics as designed and in total, combine to implement a triple-lock interlock which takes separate barrier members and combines into a solid assembly with a solid, seamless vertical surface for retaining materials and a solid horizontal surface on both sides of the wall which provides barrier and mow over protection that can be installed in linear, arcuate, or any combination shapes with no digging, no staking, no external connections of any sort.

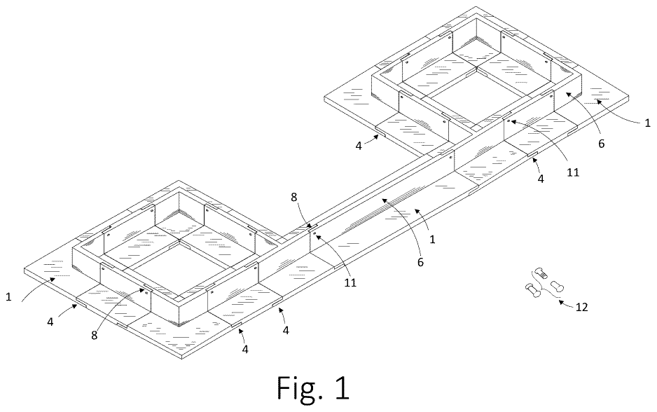

FIG. 1 is an is an assembled isometric view of multiple barrier members interconnected in the preferred embodiment of two square beds connected with a linear border. The size of the squares and the length of the linear border is adjustable with longer or shorter border members and additional members may be added while preserving the solid, seamless barrier that is created by the overlapping and interlocking barrier members.

This figure shows how multiple barrier members are abutted and interconnected to form an assembly. The physical properties manufactured into each barrier member align and connect to form a seamless solid barrier surface. Base flanges 4 overlap creating a solid horizontal surface at each connection point. Wall flanges 8 overlap creating a solid vertical surface at each connection point. Base tabs insert into base slots creating an interlock thereby preventing transverse or vertical movement. Base tabs and base slots are not visible in this assembled view but are detailed in subsequent drawings. Lastly, lock pin holes 11 in each wall flange 8 overlap and align so that lock pins 12 are inserted and secured into position preventing the barrier members from separating. This ensures connected members stay locked in position creating a solid seamless barrier assembly that is freestanding, self-connected, and self-supported thereby requiring no external anchors, stakes or braces. The invention allows for the assembly and installation on concrete or rock substrate as well as lawns and soil. This would allow a paver patio or resin-bound gravel to be installed over an existing concrete patio and extending out onto adjacent soil surface. This is a significant improvement over prior art.

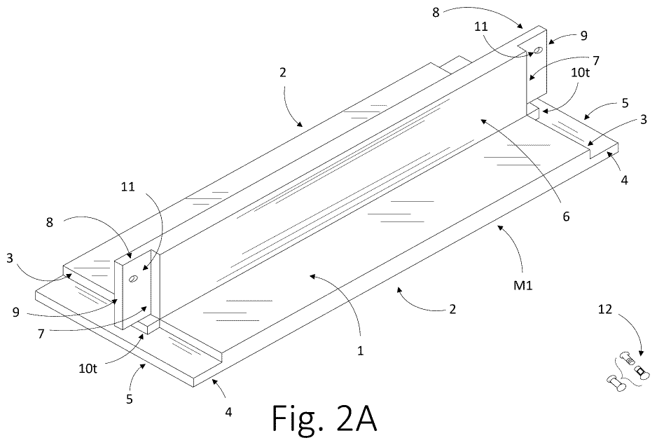

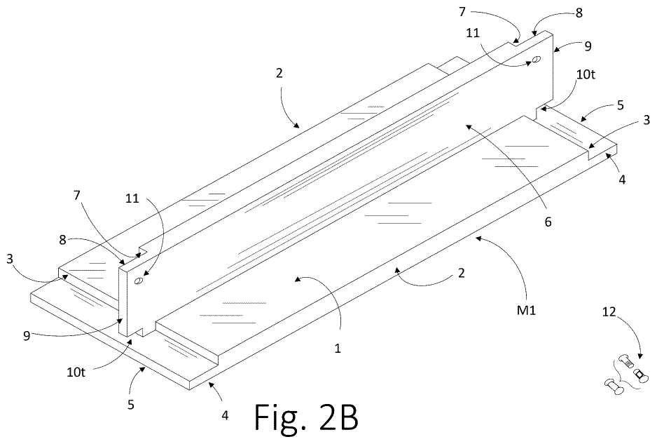

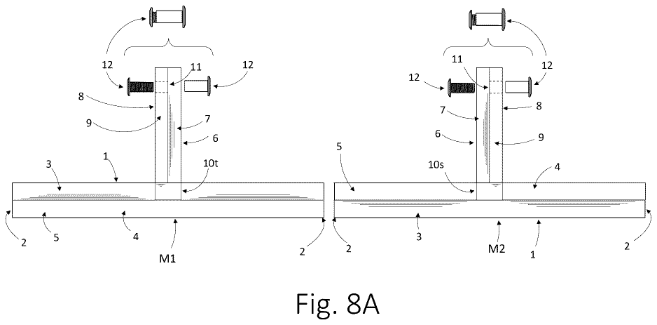

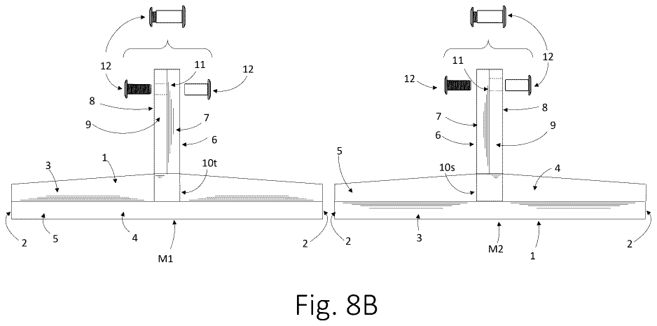

FIG. 2A is an isometric view of barrier member 1 referenced as M1 in the drawing. Barrier member 1 comprises a base 1 with an elongate planar surface with opposite first and second base ends 3 and having two oppositive, longitudinal base sides 2 that are parallel to each other. The base 1 is sufficiently wide to be freestanding. The base 1 is depicted flat but may include a transverse slope down from the center to the base sides 2. This slope is further depicted in FIG. 8B. The base 1 is solid and relatively thin and manufactured from material substantially rigid and suitable for permanent outdoor installation such as HDPE.

Barrier member M1 includes base flanges 4 equal in width to the base 1 and extending from the bottom of the base ends 3 and extends to the flange ends 5. The height of the base flange 4 is such that two base flanges overlapped are equal in height to the base. The base flange 4 length is defined by the distance between the base flange end 5 and the base end 3.

Barrier member M1 includes a wall 6 which extends generally upward vertical from and integral to the base 1 and extends longitudinally between opposite base ends 3 terminating in wall ends 7. The wall 6 is intermediate and parallel to the base sides 2. The wall 6 may be of different height and widths for different use cases.

Barrier member M1 includes wall flanges 8 equal in height to the wall 6 and extending from the wall ends 7. The wall flanges 8 may extend from either side of the wall ends 7 such that wall flanges 8 of adjacent abutted barrier members will overlap. The width of the wall flange 8 is such that two overlapped wall flanges 8 are equal in width to the wall 6. The wall flanges 8 include a lock pin hole 11 placed in a manner to align with a similar lock pin hole 11 on overlapped wall flanges.

Barrier member M1 includes base tabs 10t on the base flanges 4 extending from the bottom of the base ends 3. The base tabs 10t are rectangular or square in shape and integral with and extends on top of the base flange 4 and is somewhat shorter than the base flange. 4. The base tab 10t height is such that the base tab 10t on top of the base flange 4 is equal in height to the base 1. The base tab 10t is underneath and integral to part of the wall flange 8.

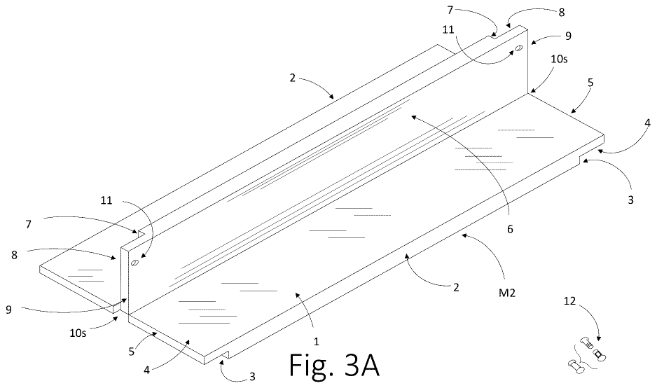

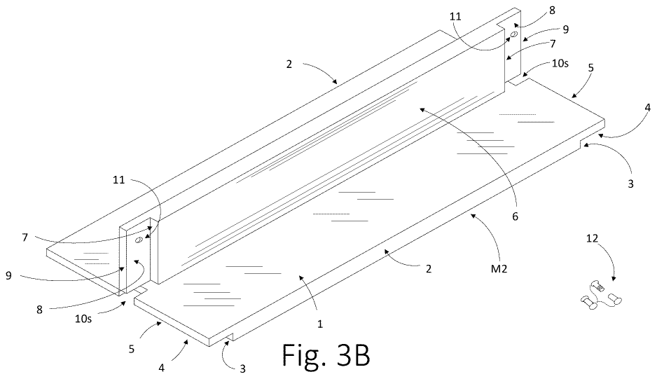

Barrier member M1 as depicted does not include a base slot however this invention allows for alternating base flange, base tab, base slot combinations. In this scenario, the base flange on one end would extend from the bottom of the base end and would include a base tab. The opposite base end would include a base flange extending from the top of the base end and would incorporate a base slot. Base slot details are provided in the detailed description of FIG. 3A.

Barrier member M1 includes a lock pin hole 11 on each wall flange 8 and is positioned to align with additional lock pin holes 11 on overlapped wall flanges 8 of adjacent, abutted members. The lock pin holes are somewhat oblong, wider than the lock pin to allow a slight flex to accommodate thermal expansion and contraction. A lock pin 12 is included to insert through lock pin holes 11 on assembly of overlapping wall flanges. The lock pin 12 is somewhat smaller in diameter than the width of the lock pin hole 11. The lock pin 12 has a lock pin head that is substantially larger than the lock pin hole 11 to provide full coverage of the lock pin hole 11 such that full coverage of the vertical surface is provided once assembled.

FIG. 2B is an isometric view of barrier member 1 referenced as M1 in the drawing. This view shows an opposite side view of FIG. 2A. This shows additional detail on the base flange 4, wall flange 8, and base tab 10t alignment. Barrier member 1 base tab 10t extends out from the base end 3 and on top of and integral with the base flange 4. The wall flange 8 overlaps and is integral with a portion of the base tab 10t. These physical characteristics along with the horizontal base 1, wall 6, base slots in adjacent abutted barrier members, Lock Pin Holes 11, and lock pins 12 establish a new form with unique properties that enable barrier members to connect in a triple-lock joint creating freestanding, self-connecting, and self-supporting assemblies that provide a seamless, solid surface across the horizontal and vertical surface across the entire assembly.

FIG. 3A is an isometric view of barrier member 2 referenced as M2 in the drawing. Barrier member 2 comprises a base 1 with an elongate planar surface with opposite first and second base ends 3 and having two oppositive, longitudinal base sides 2 that are parallel to each other. The base 1 is sufficiently wide to be freestanding. The base 1 is depicted flat but may include a transverse slope down from the center to the base sides 2. The base 1 is solid and relatively thin and manufactured from material substantially rigid and suitable for permanent outdoor installation.

Barrier member M2 includes base flanges 4 equal in width to the base 1 and extending from the top of the base ends 3 to the base flange end 5. The height of the base flange 4 is such that two base flanges overlapped are equal in height to the base. The base flange 4 length is defined by the distance between the base flange end 5 and the base end 3.

Barrier member M2 includes a wall 6 which extends generally upward vertical from and integral to the base 1 and extends longitudinally between opposite base ends 3 terminating in wall ends 7. The wall 6 is intermediate and parallel to the base sides 2. The wall 6 may be of different height and widths for different use cases.

Barrier member M2 includes wall flanges 8 equal in height to the wall 6 and extending from the wall ends 7. The wall flanges 8 may extend from either side of the wall ends 7 such that it will overlap an adjacent abutted member wall flange. The width of the wall flange 8 is such that two overlapped wall flanges 8 are equal in width to the vertical wall 6. The wall flanges 8 include a lock pin hole 11 placed in a manner to align with a similar lock pin hole 11 on overlapped wall flanges 8.

Barrier member M2 includes base slots 10s in the base flanges 4. The base slot 10s extends from base flange end 5 inwards towards the base edge 3 and is equal in width to the wall 6 and to a base tab 10t on an adjacent abutted member. The base slot 10s is somewhat shorter than the base flange 4 with the length being equal to base tab 10t on an adjacent member to be abutted and interconnected upon assembly. The base slot 10s is underneath a portion of the wall flange 8 such that when adjacent abutted barrier members are interconnected, the overlapping wall flanges 8 are on top of the base tab 10t and base slot 10s connection thereby locking the barrier members in place on the vertical and transverse axis.

Barrier member M2 as depicted does not include a base tab 10t however this invention allows for alternating base flange, base tab, base slot combinations. In this scenario, the base flange on one end would extend from the bottom of the base end and would include a base tab. The opposite base end would include a base flange extending from the top of the base end and would include a base slot. Base tab details are provided in the detailed description of FIG. 2A.

Barrier member M2 includes a lock pin hole 11 on each wall flange 8 and is positioned to align with additional lock pin holes 11 on overlapped wall flanges 8 of adjacent, abutted members. The lock pin holes are somewhat oblong and are wider than the lock pin to allow a slight flex to accommodate thermal expansion and contraction. A lock pin 12 is included to insert through lock pin holes 11 on assembly of overlapping wall flanges. The lock pin 12 is somewhat smaller in diameter than the width of the lock pin hole 11. The lock pin 12 has a lock pin head that is substantially larger than the lock pin hole 11 to provide full coverage of the lock pin hole 11 ensuring full coverage of the vertical surface

FIG. 3B is an isometric view of barrier member 2 referenced in the drawing as M2. This view shows an opposite side view from FIG. 3A. This shows additional detail on the base flange 4, wall flange 8, and base slot 10s alignment. Barrier member 2 base slot 10s extends in from the base flange end 5 underneath part of the wall flange 8. The insertion of a base tab into the base slot which is intermediate the wall flange and base flange creates an interlock. This combination of physical characteristics along with the horizontal base 1, wall 6, base tabs in adjacent abutted barrier members, Lock Pin Holes 11, and lock pins 12 enable barrier members to connect in a triple-lock joint creating freestanding, self-connecting assemblies that provide a seamless, solid surface across the horizontal and vertical surface across the entire assembly.

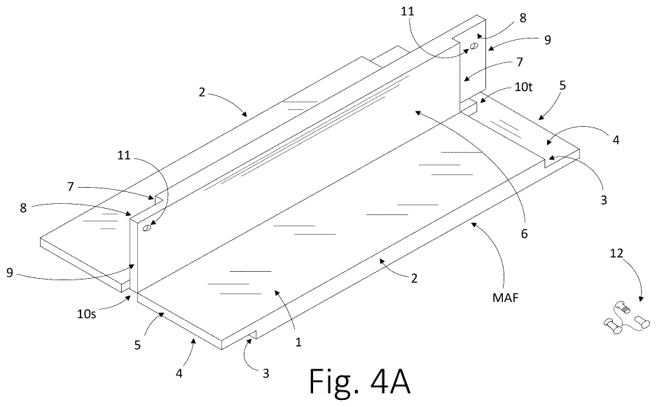

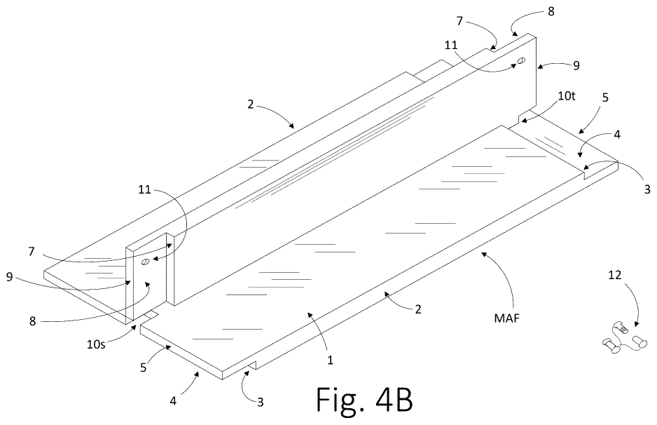

FIG. 4A is an isometric view of barrier member AF reference in the drawing as MAF. Barrier member AF is similar to Member 1 and Member 2 yet with different flange orientations. The core invention of the unique physical characteristics that enable the triple-lock interconnection between barrier members remains that same. Member AF includes a base 1, a wall 6, and base flanges 4 that extend from either the top or bottom of the base 1 as well as wall flanges 8 that extend from either side of the wall 6. A base flange that extends from the top of the base includes a base slot 10s while a base flange that extends from the bottom of the base includes a base tab 10t. FIG. 4A shows barrier member AF with one base flange 4 that extends from the top of the base 1 and incorporates a base slot 10s. The opposite end includes a base flange 4 that extends from the bottom of the base 1 and incorporates a base tab 10t. FIG. 4A also shows wall flanges 8 that extend from opposite sides of the wall 6. This shows how the barrier members can have different configurations of base flanges, base slots, base tabs, and wall flanges and still provide the triple-lock interconnect such that two barrier members lock into place preventing movement and separation on the x, y, and z axis.

FIG. 4B include an isometric view of barrier member AF similar to FIG. 4A but with the wall flanges 8 extending from opposite sides of the wall 6. This provides additional clarity on how the orientation of the base flanges with base slots and base tabs, and wall flanges all designed to work together to provide an overlapping and interlocked horizontal and vertical surface across connected barrier members. Once connected these barrier members are locked in place in a secure, free-standing, self-connected, self-supported assembly.

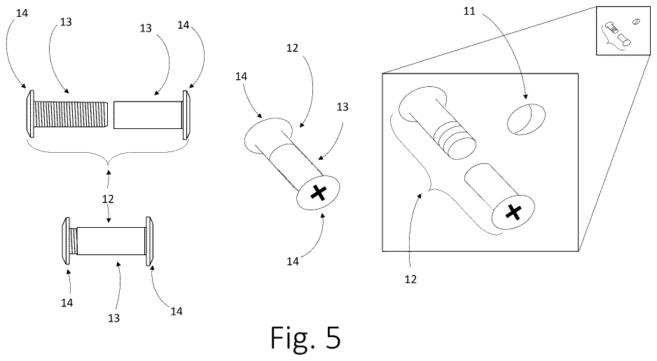

FIG. 5 includes isometric views of assembled and exploded Lock Pins 12. Also included is an Elevation View of a Lock Pin 12 exploded and assembled. Each Lock Pin 12 comprises two parts, Lock Pin Head 14 and Lock Pin Shaft 13. The Lock Pin Shaft inserts into a two Lock Pin Holes 11 which are aligned due to the overlap of the Wall Flanges of connected members. The Lock Pin 12 may be threaded and screw together or it may snap together to lock in place. The Lock Pin head 14 is significantly larger than the Lock Pin Hole 11 providing solid coverage of a resulting Vertical Wall assembled surface. The Lock Pin Shaft 13 is significantly smaller than the Lock Pin Hole 11 providing for longitudinal expansion and contraction.

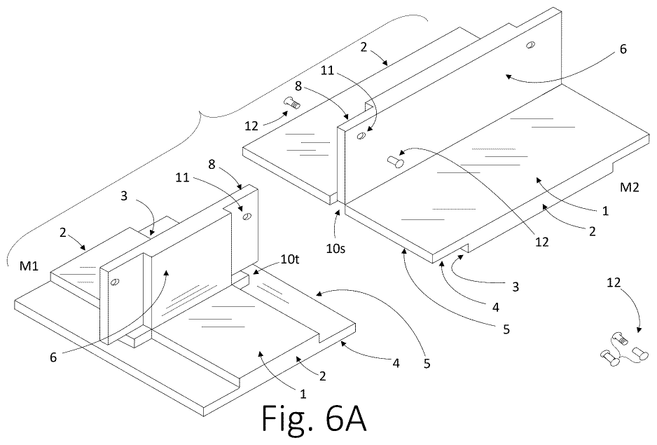

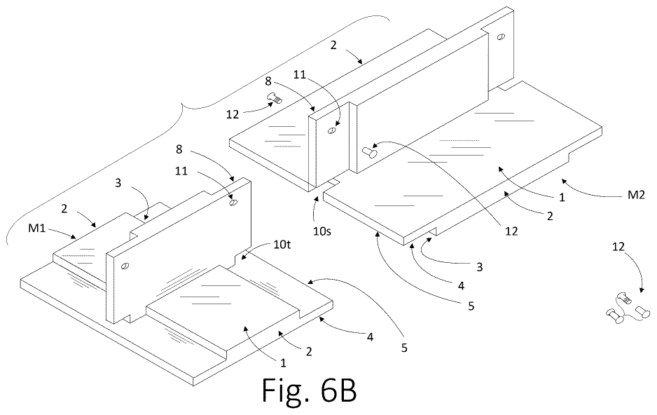

FIG. 6A is an exploded isometric view of barrier member units aligned for fitment. Barrier member 1 referred to as M1 in the drawing and barrier member 2 referenced as M2 in the drawing, as previously described in FIG. 1 and FIG. 2. The base flanges 4 of abutted members overlap and in combination are equal in height as the base 1. The base tab 10t of barrier member 1 inserts into the base slot 10s of barrier member 2 which locks both units into place and prevents transverse and vertical movement. The wall flanges 8 of abutted members overlap and in combination are equal in width to wall 6. The wall flanges overlap above the base tab 10t and base slot 10s combination thereby locking the interconnected barrier members into place and preventing movement up, down, forward or backward. Lastly, a Lock Pin 12 is inserted through the Lock Pin Holes 11 that are overlapped and aligned. The lock pin prevents separation of the connected members ensuring the other overlapping surfaces are always engaged. This invention provides the unique combination of physical characteristics that creates the triple-lock joint to interconnect members resulting in an elongate assembly with solid surfaces that span both members. This invention creates a solid, seamless junction between members that can connect different units to create both linear and arcuate assemblies that include solid horizontal and vertical surfaces that can be adapted to different shapes.

In FIG. 6B, is an opposite side view of FIG. 6A with barrier member 1 and barrier member 2 aligned for fitment. Base edges 2 on both members are parallel. The base flange end 5 of barrier member 2 is placed adjacent and against the base end 3 of barrier member 1. The base flange end 5 of barrier member 1 is placed adjacent and against the base end 3 of Member 2. Base flange 4 of Member 1 overlaps base flange 4 of Member 2. This results in a solid horizontal surface spanning across both adjacent and abutted barrier members. The base tab 10t of barrier member 1 is inserted into base slot 10s of barrier member 2. The resulting interlock creates a secure connection that prevents sideways movement along the transverse axis. Additionally, barrier member 2 wall flange 8 overlaps barrier member 1 wall flange 8 creating a solid vertical surface spanning both adjacent barrier members. The lock pin 12 inserts into the lock pin holes 11 which overlap on each wall flange 8 creating a solid and secure vertical wall that is locked into place. The resulting vertical surface spanning both barrier members is solid and locked in place preventing movement up, down, front, or backwards. This creates a seamless longitudinal horizontal and vertical barrier. The resulting completed configuration locks both barrier members together as a single apparatus preventing separation and thereby creating a complete interlocking system. Additional barrier members of varying shapes are attached using the same interlocking joint which allows for a wide variety of configurations and use cases.

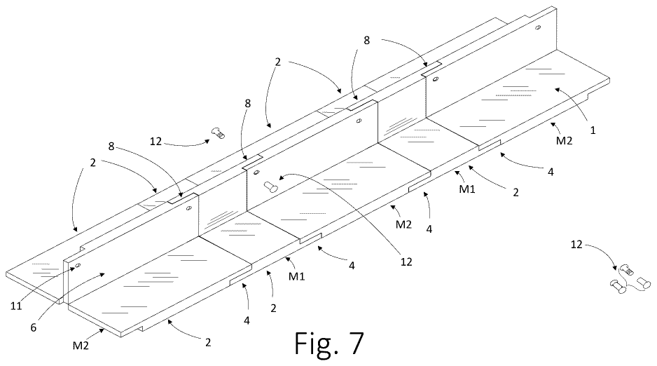

FIG. 7 is an assembled isometric view of a linear assembly of multiple barrier member 1 and barrier member 2 units, referenced in the drawing as M1 and M2 units respectively. This shows how this inventions unique properties provide for multiple barrier members to combine into a seamless, solid, interlocked elongated linear assembly or apparatus. Each barrier member is of indeterminate length allowing for very long combined assemblies. Width of barrier members may also be different and variable but typically the same width per installation or assembly for uniformity. The result is an elongated installation made of multiple barrier members with overlapping surfaces on the horizontal and vertical planes creating a solid border barrier to retail materials and prevent spread across the horizontal and vertical surfaces. This innovation allows for multiple additional barrier members of different shapes including angled units, arcuate units, and units that alternate the horizontal or vertical flange to either side of the base or wall. This innovation enables all members to use the same interlocking joint to interconnect creating a solid, seamless apparatus.

The fitment of multiple barrier member 1 and barrier member 2 units are abutted and interconnected by the engagement of base flanges 4, wall flanges 8, with the base slots 10s and base tabs 10t, and the lock pin holes and lock pins. Abutted barrier members slide into place to create seamless interlocked horizontal and vertical surfaces thereby becoming a solid integrated unit across all three dimensions. The innovation in the connection between barrier members represents an improvement in the state of the art in creating solid border edge and retain barrier system.

FIG. 8A is an elevation view of the end or barrier member 1, referred to as M1 in the drawing, and barrier member 2, referred to as M2 in drawing. The physical characteristics of the end of each barrier member is the critical element of this invention. The unique combination of overlapping base flanges and wall flanges, with the base tab and base slot connection, all held together with the lock pins to create a triple lock joint that securely connect each barrier member and prevent penetration of landscape materials across the horizontal and vertical barriers.

Barrier member 1, M1 in the drawing, includes a base 1 with opposite first and second base ends 3 and having opposite base sides 2, the base is sufficiently wide that the barrier member is free standing. A base flange 4 extends from the bottom of the base 1 and is defined by the base end 3 and base flange end 5. The distance between the base flange end 5 and the base end 3 defines the length of the base flange 4. A wall 6 extends generally upward vertical from and integral to the base 1, is intermediate the opposite base sides 2 and extends longitudinal between the wall ends 7. A wall flange 8 extends from either side of the wall end 7. The distance between the wall end 7 and the wall flange end 9 defines the length of the wall flange 8. The wall flange 8 includes a lock pin hole 11 which is aligned with a lock pin hole 11 on an adjacent and abutted barrier member. A lock pin 12 is inserted and extends through both overlapped wall flanges upon installation. A base tab 10t is rectangular or square in shape and extends from base end 3 some distance less than the length of the base flange 4. The base tab 10t is intermediate the base flange 4 and wall flange 8 and beneath and adjacent to the wall flange 8.

Barrier member 2, M2 in the drawing, includes a base 1 with opposite first and second base ends 3 and having opposite base sides 2, the base is sufficiently wide that the barrier member is free standing. A base flange 4 extends from the top of the base 1 and is defined by the base end 3 and base flange end 5. The distance between the base flange end 5 and the base end 3 defines the length of the base flange 4. A wall 6 extends generally upward vertical from and integral to the base 1, is intermediate the opposite base sides 2 and extends longitudinal between the wall ends 7. A wall flange 8 extends from either side of the wall end 7. The distance between the wall end 7 and the wall flange end 9 defines the length of the wall flange 8. The wall flange 8 includes a lock pin hole 11 which is aligned with a lock pin hole 11 on an adjacent and abutted barrier member. A lock pin 12 is inserted and extends through both overlapped wall flanges 8 upon installation. A base slot 10s which is rectangular or square in shape is included in the base flange 4. The base slot 10s extends from the base flange end 5 towards the base end 3 and is beneath and adjacent to the wall flange 8. The length of the base slot 10s is somewhat less than the length of the base flange 4. The base slot is the same size and shape as a base tab on an adjacent barrier member that will be connected upon installation.

FIG. 8B is an elevation view of the end or barrier member 1 M1 and barrier member 2 M2 with the base 1 incorporating a slope. All other elements are the same. These members will connect to other members with a similarly slopped base using the same combination of base flanges 4, wall flanges 8, base tabs 10t, base slots 10s, lock pin holes 11, and lock pins 12 which in combination establish the triple-lock interconnection between barrier members.

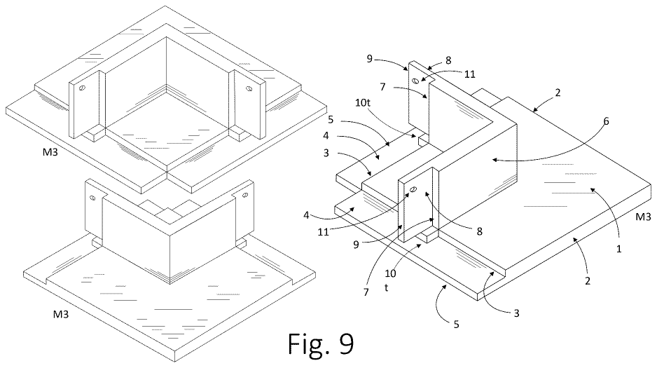

FIG. 9 depicts isometric views of barrier member 3 in different orientations. Barrier member 3, referenced as M3 in the drawing, incorporates a 90-degree angle to provide a change in direction of the barrier member. Barrier member 3 comprises a base 1 generally square in shape yet could also be L shaped. Barrier member 3 comprises two adjacent base sides 2 which connect at a 90-degree angle and extend perpendicular to each other. Member 3 comprises two adjacent base ends 3 which connect at a 90-degree angle and extend perpendicular to each other. The two base sides 2 are opposite and opposing the two base ends 3. Member 3 is further comprising two base flanges 4 which extend from the bottom of the base ends 3. The base flange 4 depth is such that when connected with an abutting and adjoining barrier member with an overlapping base flange, the combined full height is equal to the base 1 height. The base flanges 4 extend from the bottom of the base ends 3 and are defined by the base flange end 5 and the base end 3. The distance between the base flange end 5 and the base end 3 defines the depth or length of the base flange 4. A wall 6 includes two sections which intersect at a 90-degree angle in the center of the base 1. The wall 6 sections extend longitudinally parallel to the base sides 2 to the base ends 3 where the wall terminates in wall ends 7. Wall flanges 8 equal in height to the wall 6 and extending from either side of the wall ends 7 such that it will overlap an adjacent abutted barrier member wall flange. The length of the wall flange 8 is defined by the distance between the wall ends 7 and a wall flange ends 9. The width of the wall flange 8 is such that two overlapped wall flanges 8 are equal in width to the wall 6. The wall flanges 8 include a lock pin hole 11 placed in a manner to align with a similar lock pin hole 11 on overlapped wall flanges. A base tab 10t extends from the bottom of the base ends 3. The base tabs 10t are rectangular or square in shape and integral with and extends on top of the base flange 4 and is somewhat shorter than the base flange. 4. The base tab 10t height is such that the base tab 10t on top of the base flange 4 is equal in height to the base 1. The base tab 10t is equal in width to the wall 6 and is underneath and integral to part of the wall flange 8. Member 3 includes lock pin holes 11 in each wall flange which allows for placement of a lock pin 12 to secure the abutted and overlapped wall flanges from adjoined and attached barrier members. The base 1 may be flat as shown or may be slopped downward from the wall 6 to the base sides 2. The angle incorporated may be greater than 90-degrees up to 180-degrees.

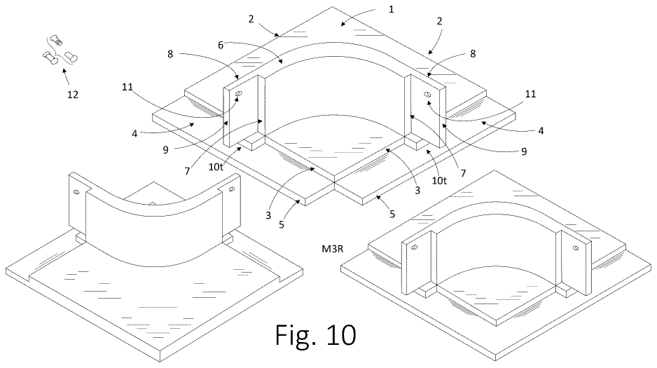

FIG. 10 provides isometric views of barrier member 3R in different orientations. Barrier member 3R is a corner unit like barrier member 3 as adapted to form a curve. Barrier member 3R has the same base 1, base flanges 4, base tabs 10t, wall flanges 8 and lock pin hole characteristics as barrier member 3. Barrier member 3R key difference is the wall 6 is arcuate curving between the wall flanges 8.

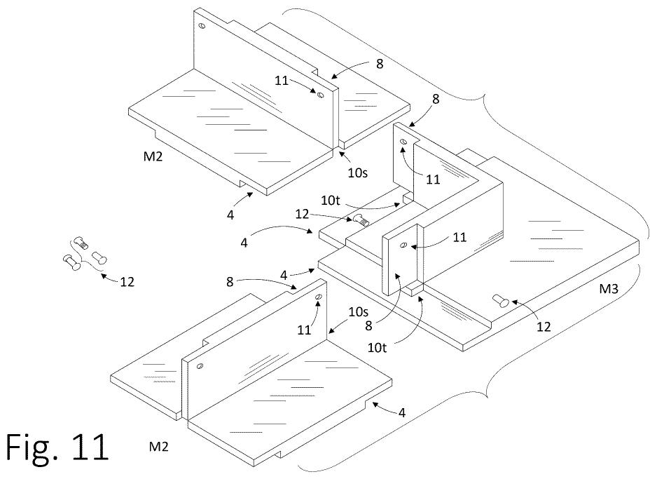

FIG. 11 is an exploded isometric view of a two barrier member 2 units and a barrier member 3 unit aligned for fitment. Barrier members are aligned to interconnect with a specific alignment of the physical characteristics including base flanges 4, wall flanges 8, base slots 10s, base tab 10t, lock pin holes 11, and lock pins 12, such that abutted connected barrier members create a solid interlocked border barrier surface that contains landscape materials or vegetation preventing spread or penetration across all three dimensions. In this figure specifically, Barrer member 3 is placed on the installation surface. Barrier member 2 base flange 4 is placed on top of the base flange of barrier member 3. The base tab 10t of barrier member 3 inserts into the base slot 10s of barrier member 2. The wall flange 8 of barrier member 3 overlaps the wall flange 8 of barrier member 2. Lock pin holes 11 on the wall flanges 8 are aligned such that lock pins 12 are inserted through both wall flanges 8 to complete the interconnect. The resulting completed assembly is locked together as a single apparatus preventing separation and thereby creating a complete interlocking system. Additional members of varying shapes are attached using the same interlocking joint which completes a seamless, interlocked border edge and retain barrier that is an innovation to the art.

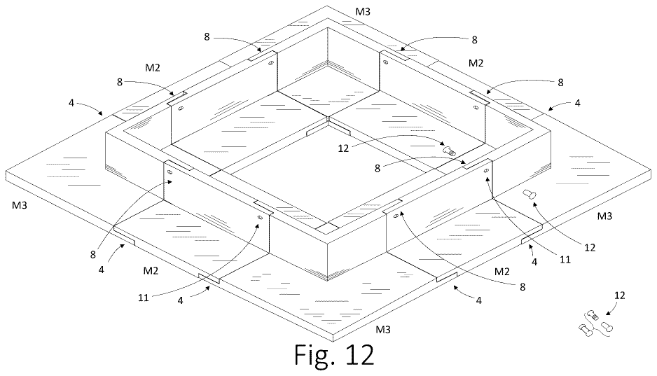

FIG. 12 is an assembled isometric view of multiple barrier members in a square bed assembly which is a preferred embodiment of this invention. This shows how the fitment of multiple barrier member 2 and barrier member 3 units, referenced in the drawing as M2 and M3, respectively, are abutted and interconnected by the engagement of the base flanges 4, wall flanges 8, with the base slots 10s and base tabs 10t, and the lock pin holes 11 and lock pins 12. The resulting assembly is a solid border, edge barrier apparatus that is freestanding, self-connected, self-supported and provides mow over surface on both sides. The barrier member 2 units are of indeterminate length resulting in elongated sides and can be extended with multiple additional barrier member 2 and or barrier member 1 units resulting in larger square or rectangular beds. This innovation is the physical characteristics enabling the seamless, solid connection of various barrier members of different shapes including straight units, angled units, arcuate units, and units with alternating horizontal and vertical flanges, all with the same triple locking joint to interconnect piece parts creating a solid, seamless apparatus. This invention will be used to create square landscape beds on soil in yards but also on concrete patios. This square bed can be installed freestanding on a concrete patio and filled with pavers or tiles. This square bed can be installed on a lawn and filled with soil for plantings securing the materials in place and providing mow over surface facing the lawn. This square bed can be installed around a mailbox or flagpole and filled with mulch securing the materials in place and providing a mow over surface facing the lawn. This square bed can be placed on any flat surface and filled with concrete becoming a patio or walkway section with a mow over surface facing the lawn. This Square Bed can be placed on any flat surface and filled with deck planks creating a picture framed quick deck. The ease and flexibility of this invention is a significant advancement versus prior art.

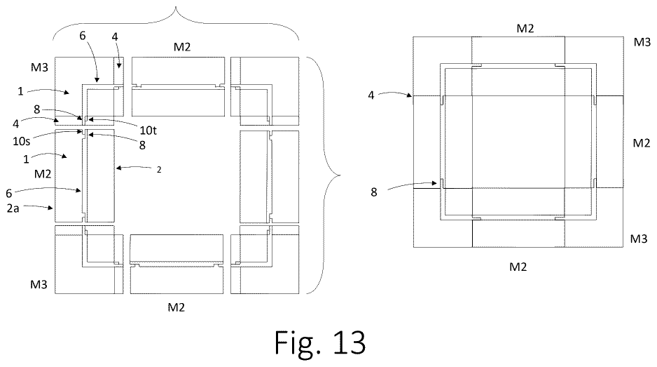

FIG. 13 includes an exploded and assembled plan view from the top of a preferred embodiment of a square bed created from the fitment of multiple barrier member 2 and barrier member 3 units, referenced in the drawing as M2 and M3 respectively. Barrier member 3 includes a base 1 and base flange 4 which overlap with the base flange on barrier member 2. Barrier member 3 wall flange 8 overlaps with barrier member 2 wall flange. Barrier member 3 base tabs 10t insert into barrier member 2 base slots 10s. Lock pins are not shown in this plan view, but they insert into lock pin holes in the wall flanges 8 which are not visible in this plan view. Member 3 square corners can be replaced Member 3R round corners to create rounded edge beds. Additional barrier member 2 and barrier member 1 units may be added to extend the length making larger square or rectangular beds.

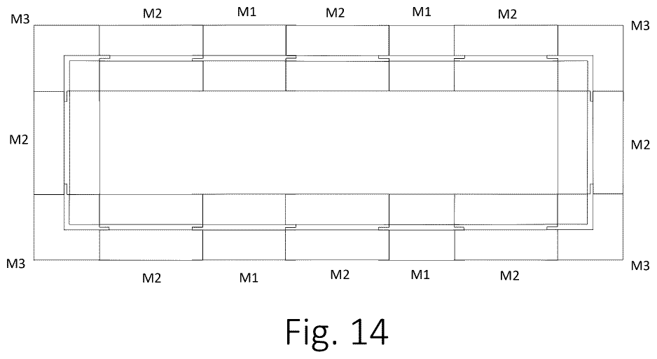

FIG. 14 is an assembled plan view from the top of a preferred embodiment of a rectangular bed with multiple barrier member 1, barrier member 2 and barrier member 3 units, referenced in the drawing as M1, M2, and M3 respectively. This shows how multiple barrier members can be assembled using this inventions unique physical characteristics of base flanges, base tabs, base slots, wall flanges, lock pin holes and lock pins to create a long bed assembly with solid, seamless horizontal and vertical surfaces. This invention will work well with new materials such as Geogrid and Geocell for soil and gravel stabilization to prevent excess pressure on the vertical wall retaining surface. This invention will also work very well with Gravel-Lok resin bonded gravel surfaces to create very fast and economical landscape surfaces.

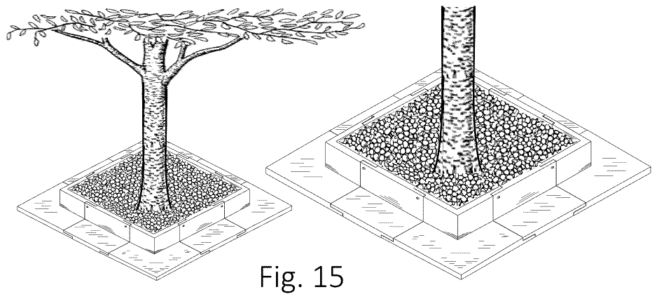

FIG. 15 is an isometric view of a preferred embodiment of a square bed assembled and installed as a landscape bed used as a tree surround. The surround as depicted is filled with gravel landscape material. The gravel is on top of the horizontal base on the inside of the assembly which helps secure the complete assembly in position. The overlap of the base flanges and wall flanges along with the insertion of base tabs into base slots and lock pins in lock pin holes at each joint establish the seamless, solid surface across members. The horizontal base on the outer edge provides for a solid mow over surface.

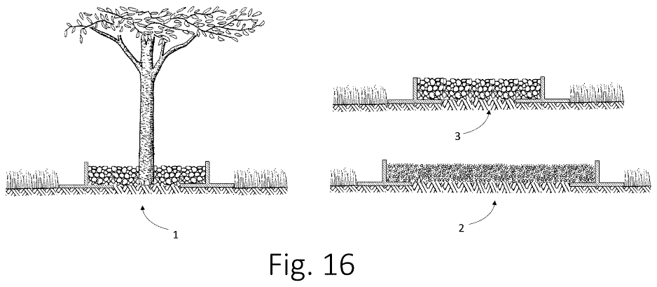

FIG. 16 includes elevation views of cross sections of a preferred embodiment of square bed assemblies in various landscape applications. Image 1 is a tree surround filled with gravel. Image 2 is a patio or path filled with concrete. Image 3 is a patio or path filled with gravel. These images show how the horizontal base provides a horizontal barrier on both sides of the wall. These images also show how the wall functions to retain various materials. This is unique due to the triple-lock joint that connects multiple members into a solid seamless horizontal and vertical surface.

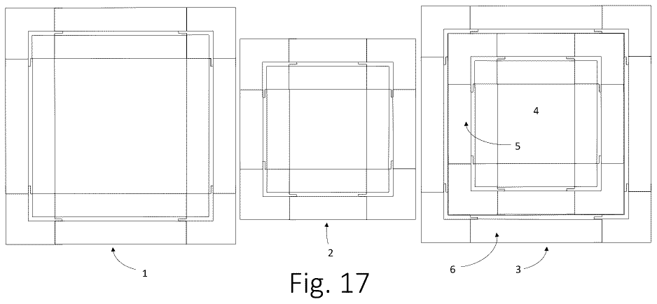

FIG. 17 is plan view of an additional preferred embodiment of this invention of two square beds combined to create a nested bed with curb. Square bed 1 is the outer assembly and square bed 2 is the inner assembly for this preferred embodiment. Nested bed with curb 3 is the combination of square bed 1 outer assembly which is installed first and placed in position. Square bed 2 inner assembly is then installed inside of square bed 1 outer assembly with the bases overlapping to create a solid horizontal surface between the walls of both units. The resulting nested beds with curb final assembly 3 has an internal bed 4 to hold landscape materials, plants, mulch, gravel, concrete, etc. Also included is a channel 5 between the wall of bed 1 and the wall of bed 2 which surrounds the internal bed 4 and can be filled with concrete, gravel, soil, pavers, to create a curb. This assembly is an innovation in border edge and retain barriers enabled by this invention. No other border barrier system provides a freestanding, self-connecting apparatus capable of producing this bed and curb combination. This innovation works particularly well with newer resin bonded gravel surface materials such as Gravel-Lok. The width and area of the channel may be adjusted based on the width of the horizontal base employed. And lastly included is the exterior horizontal surface 6 which surrounds the complete assembly providing integral mow over protection. This design uses the joint innovation to connect the piece parts into a solid, interconnected apparatus that holds various materials in place.

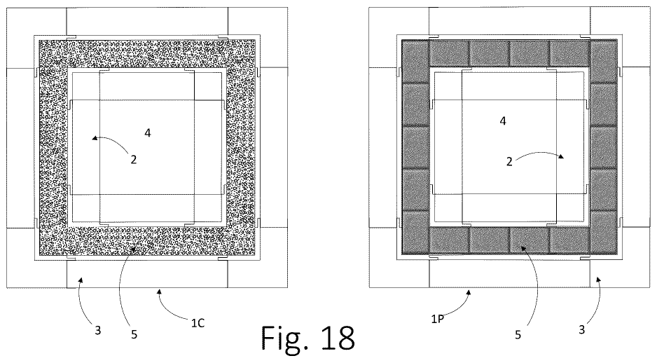

FIG. 18 includes plan views of the top of a preferred embodiment of nested beds with curb. This shows a nested bed with curb final assembly 1C which includes an internal bed 4 with the channel 5 filled with concrete. This also shows a nested bed with curb final assembly 1P which includes an internal bed 4 with a channel 5 filled with paver stones. Both assemblies include an external horizontal surface 3 which provides mow over protection.

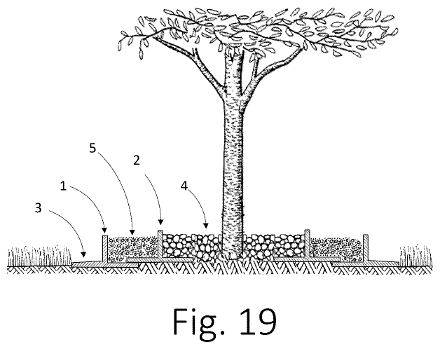

FIG. 19 is an elevation view of a cross section of a preferred embodiment of a nested beds with curb installed as a landscape bed used as a tree surround. This figure shows a cross-section view of an outer assembly 1. An inner assembly 2 which defines the internal bed 4 which contains a tree and gravel. A channel 5 is defined by the space between the wall of the inner and outer assemblies. The channel 5 is filled with concrete creating a solid curb. Also included is a solid horizontal surface 3 which surrounds the entire assembly providing a mow over surface.

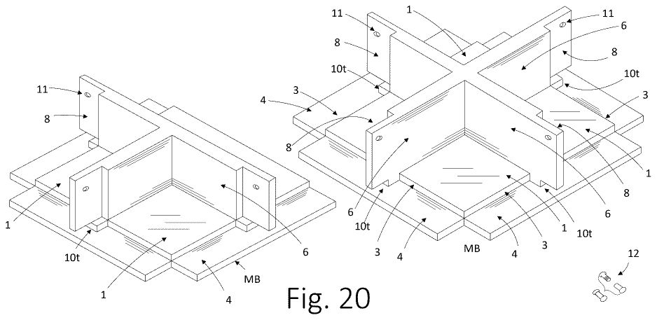

FIG. 20 includes isometric views of barrier member B, referenced as MB in the drawing. Barrier member B is a connector that includes the triple-lock joint on multiple edges providing for a border edge barrier assembly to branch into multiple directions. FIG. 20 shows a three-way and a four-way barrier member B. Each barrier member B includes a base 1 with base flanges 4 extending from the base end 3. The three-way barrier member B includes a base side that does not connect to an adjacent member. The four-way barrier member B includes a base end and base flange on all four sides. The wall 6 has 3 segments on the three-way barrier member and 4 segments on the four-way barrier member. The wall 6 segments extend from a middle point of the base extending out to terminate at each base end 3. Wall flanges 8 extend from either side of each base end 3 of each wall 6 segment. Base tabs 10t extend from base ends 3, lock pin holes 11 are in each wall flange 8. Lock pins 12 insert through the lock pin holes 11 of overlapped wall flanges 8 upon connection to abutted members. By incorporating the triple-lock joints, Member B elements enable other members to interconnect creating solid, seamless horizontal and vertical surface that branches out in multiple directions. This innovation enables the creation of multiple bed assemblies of freestanding, self-supporting and self-connected border edge and barriers that provide seamless, solid horizontal and vertical surfaces across the entire assembly.

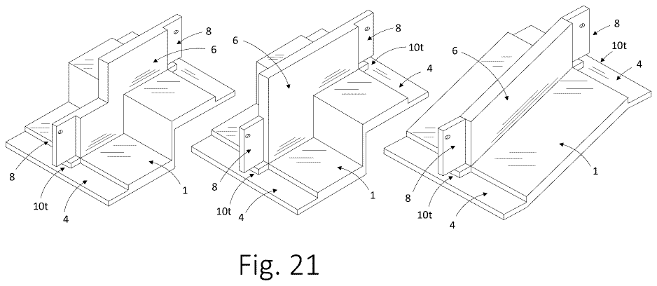

FIG. 21 depicts isometric views of barrier member S which is like barrier member 1 but with a step/ramp up/down which allows the barrier member and related assembly to adapt to changes in elevation in an installation. The height of the step and ramp is variable and defined by the length and rise of the base 1 between the base flanges 4. Barrier member S base flanges 4 and wall flanges 8 may be alternated allowing for any combination of alternating connections. Barrier member S units are interconnected with adjacent abutted barrier members by the triple-lock joint this invention claims including the overlap of base flanges and wall flanges of adjoining barrier members, along with the insertion of base tabs into the base slots of adjoining barrier members, and the insertion of lock pins into overlapped lock pin holes in the wall flanges.

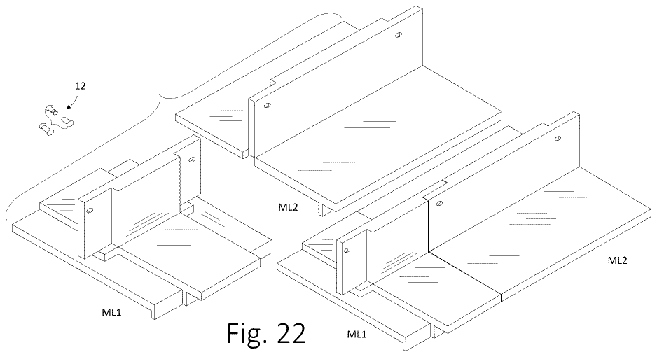

FIG. 22 includes an isometric exploded and assembled view of Barrier member L1 and Barrier member L2 units. This view shows how this invention of the triple-lock joint is extended to include an additional vertical wall or lip underneath and towards a base side. The addition of this lip enables this assembly to be installed against an existing surface such as a sidewalk or patio, in a seamless fashion. The downward lip would abut the existing sidewalk or surface. All other physical characteristics remain the same with the triple-lock joint.

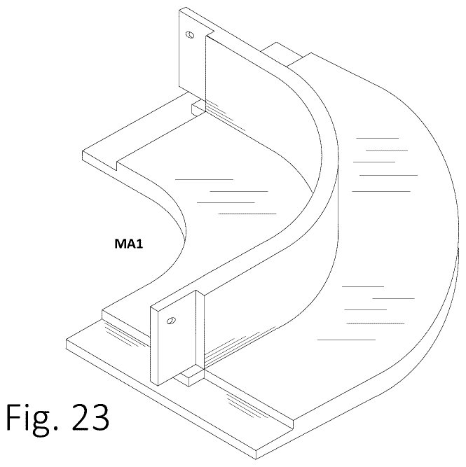

FIG. 23 is an isometric view of barrier member A1, referenced in the drawing as MA1, which is an arcuate member of varying degrees, lengths, and widths. A similar barrier member A2 is also included with the same connection type as barrier member 2 as previously described. Multiple barrier member A1 and barrier member A2 units can be connected to create a full circular assembly. Barrier member A1 and barrier member A2 units may be of varying lengths such that more or fewer units are required to complete a full 360-degree ring. This enables and creation of border barrier rings of different sizes. Barrier member A1 uses the same triple lock joint innovation such that base flanges, base tabs and base slots, and wall flanges with lock pin holes and lock pins all interconnect abutted barrier members to create a solid, seamless locked in place border edge and retain barrier apparatus in a variety of curved or arcuate shapes and sizes.

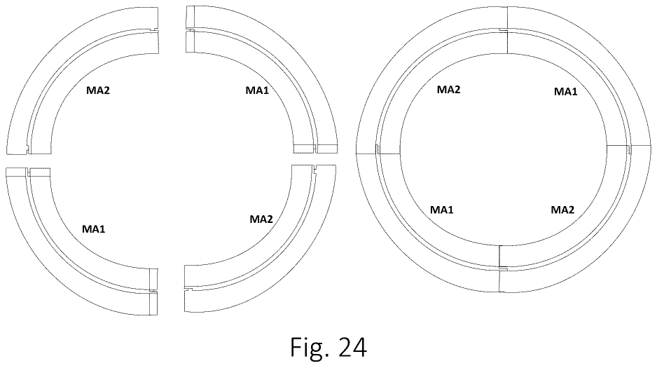

FIG. 24 provides exploded and assembled plan views of barrier member A1 and barrier member A2 units aligned for fitment in a ring assembly. Barrier member A1 and Barrier member A2 units, referenced in the drawing as MA1 and MA2 respectively, are arcuate members that include the triple-lock joint at each end. Barrier member A1 and Barrier member A2 curved shapes can be of any degree, arc, length and width. The overall shape and design of the different sizes incorporate the triple-lock joint invention wherein the base flanges overlap and interlock, the wall flanges overlap and interlock, the base tabs and base slots interlock and the lock pins insert into lock pin holes in the overlapped wall flanges creating a ring shaped solid, seamless horizontal and vertical surface spanning abutted and interlocked barrier members.

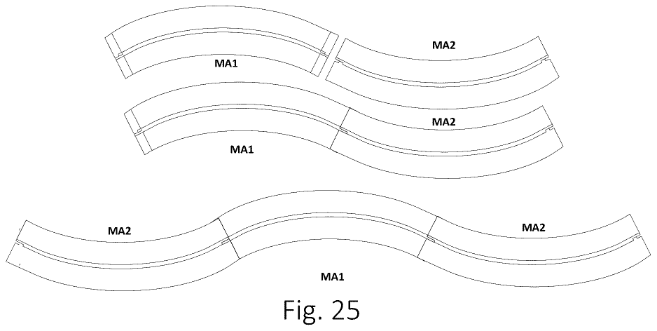

FIG. 25 provides plan views of multiple barrier member A1and barrier member A2 units, referenced in the drawing as MA1 and MA2 respectively. The barrier members are shown in exploded and assembled views of elongate arcuate assemblies. Barrier member A1 and barrier member A2 curved shapes can be of any degree and length enabling a wide curving shape that can be connected to multiple barrier members using the innovation of the triple-lock joint wherein the base flanges overlap and interlock, the wall flanges overlap and interlock, the base tabs and base slots interlock and the lock pins insert into lock pin holes in the overlapped wall flanges creating a ring shaped solid, seamless horizontal and vertical surface spanning abutted and interlocked barrier members.

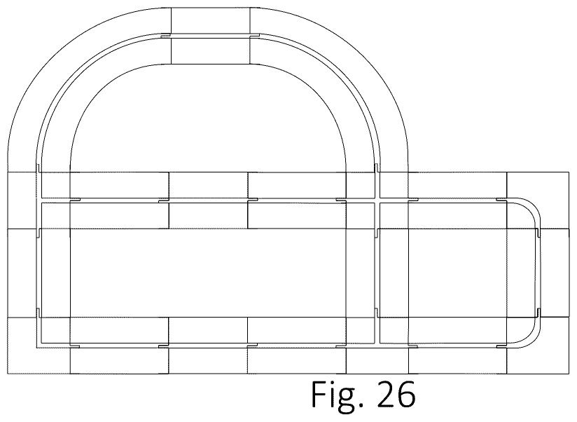

FIG. 26 includes an assembled plan view of a multi-bed assembly using multiple barrier members. Barrier member B in both a 3-way and 4-way configuration, Barrier member M2, Barrier member 3, and Barrier member 3R units are interconnected with adjacent abutted members. Each barrier member employs the triple-lock joint to interlock all members into a single solid assembly. Each triple-lock joint between members incorporates the base flange overlap, wall flange overlap, base tab insertion into base slots, which are not visible in the assembled views. Lock pins are inserted into overlapped lock pin holes which are not visible in the assembled plan view. The resulting horizonal and vertical surface spanning abutted and interlocked barrier members is solid and locks in place preventing movement up, down, front, or backwards. Any force pushing up or down is transmitted through the entire apparatus. This creates a seamless, solid horizontal and vertical barrier. Due to the freestanding, self-supporting, self-connected function of this invention, resulting assemblies can be installed on soil, gravel, rock, concrete, grass, providing significant innovation in comparison to prior art.

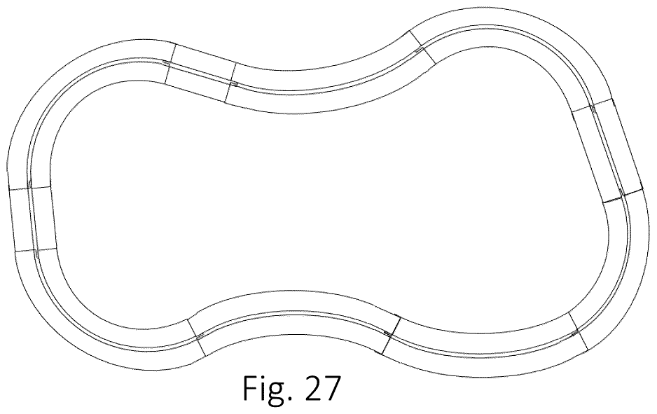

FIG. 27 provides an assembled plan view of multiple member units interconnected in a free form bed assembly. The assembly shows Barrier member 1, Barrier member 2, combined with barrier member A1 and Barrier member A2 units of varying length and shape. Each barrier member is connected using the triple-lock joint wherein the base flanges overlap and interlock, the wall flanges overlap and interlock, the base tabs and base slots insert and interlock, and the lock pins insert through the lock pin holes on overlapped wall flanges creating a solid, seamless horizontal and vertical surface which functions as a border edge and retain barrier apparatus.

The invention claimed is:

1. A landscape border edge and retain barrier apparatus comprising barrier member units manufactured with a unitary body with specific physical characteristics engineered into each barrier member thereby enabling a locking connection between barrier members into an assembly, said physical characteristics are comprising:
a. a base solid in nature, relatively thin and manufactured from material substantially rigid and suitable to permanent outdoor installation, having an elongate planar surface with opposite first and second base ends and having opposite base sides, the base is sufficiently wide that the member is free standing and thin to be mown over,
b. a base flange integral with and equal in width to the said base and extending from one or more of said base ends and from either the top or bottom of said base end, said base flange height is such that two base flanges overlapped are equal in height to said base, said base flange length is defined by the distance between the base flange end and the base end,
c. a wall solid in nature and rigid resisting pressure to flex, said wall extends generally upward vertical from and integral to said base and extends longitudinally between opposite base ends terminating in wall end edges, said wall height is proportionate to base width such that the barrier member is freestanding, said wall width is such that it resists pressure from materials being retained,
d. a wall flange integral with and equal in height to said wall and extending from one or more of said wall end edges, said wall flange may extend from either side of said wall end edge such that it will overlap an adjacent abutted barrier member wall flange, the width of said wall flange is such that two overlapped wall flanges are equal in width to said wall, said wall flange length is defined by the distance between the wall flange end and the wall end, said wall flange includes a lock pin hole positioned to overlap a similar lock pin hole on overlapped wall flanges,
e. a base tab extends from said base end and is integral with and on top of said base flange, said base tab is rectangular or square in shape and is somewhat shorter than said base flange, the base tab height is such that the base tab on top of the base flange is equal in height to said base, base tab is intermediate said base flange and said wall flange, base tab is integral with part of said wall flange,
f. a base slot is included on said base flange extending from the top of the said base end, said base slot extends from base flange end towards base end and is equal in width to base tab on an adjacent abutted member, said base slot is somewhat shorter than said base flange with length being equal to base slot on adjacent member to be abutted and interconnected upon assembly, base slot is underneath a portion of said wall flange such that said wall flange prevents tab and slot separation on vertical axis,
g. a lock pin hole is included on each wall flange and is positioned to align with additional lock pin holes on overlapped wall flanges of adjacent, abutted members, said lock pin hole is somewhat oblong being wider than the lock pin as to accommodate thermal expansion and contraction,
h. a lock pin is provided to insert through lock pin holes on assembly of overlapping wall flanges, said lock pin is someone smaller in diameter than the width of the lock pin hole, said lock pin has a lock pin head that is substantially larger that the lock pin hole to provide full coverage of said lock pin hole ensuring full coverage of the vertical surface.

2. A barrier member as in claim 1, wherein the base and wall comprise a 90 degree change in direction wherein two base sides are perpendicular and adjacent and two base ends are perpendicular and adjacent and opposite said base sides, a vertical wall with two sections that are joined in the middle of said base forming a 90-degree angle and extend out terminate in wall end edges at each said base end edge, a base flange extending from the bottom of two adjacent base end edges, a wall flange extending from either side of each wall end edge of said wall, a base tab extending from each base end edge, integral with said base flange and intermediate a portion of said wall flange and base flange, said base tab is somewhat shorter than said base flange also being equal in width to said vertical wall, a lock pin hole in said wall flange, and lock pins for insertion through said wall flanges that overlap upon assembly.

3. A barrier member as in claim 1, wherein said base comprises three base ends and one base side, a wall comprises three segments which extend from the center region of the base out to terminate at said base ends thereby forming a T shaped wall, a base flange extends from each of three base end edges, a wall flange extends from either side of each end of said wall segments, each wall flange is equal in length to said base flange, a base tab extending from said base end and above said base flange and underneath a portion of said wall flange, each base tab length is somewhat less than length of said base flange, said bast tab is equal in width to said vertical wall, lock pin holes in each said wall flange, and lock pins for insertion through said wall flanges that overlap upon assembly.

4. A barrier member as in claim 1, wherein the base and vertical wall are arcuate in shape wherein the base edges and wall curve between opposing base ends which incorporate the base flanges, base tabs, base slots, wall flanges, lock pin holes and lock pins where in multiple adjacent members can be interconnected for form complete or partial circular assemblies.

5. A barrier member as in claim 1, wherein said base and vertical wall incorporate a step that introduces a change in elevation of the two opposing ends.

6. A barrier member as in claim 1, wherein a vertical wall or lip is added to the underside of the base, also the base flange also includes a similar vertical wall enabling two units to connect thereby creating solid, seamless surface across the base, across the vertical wall and across a vertical lip on the underside of said base.

7. A barrier member as in claim 1, wherein the base slot and base flange configuration is reversed wherein the base tab is integral to a base flange extending from the top of said base end, and wherein the base slot is in a base flange extending from the bottom of said base end.

8. A barrier member as in claim 2, wherein said vertical wall curves in an arc across said base, wall flanges extend from said arcuate vertical wall on top of a portion of base tabs and base flanges.

9. A barrier member as in claim 3, wherein said base comprises four base ends with four wall segments creating a four-way branching barrier member with all the interconnection characteristics of base flanges, wall flanges, base tabs, base slots, lock pin holes, and lock pins.

10. A member barrier as in claim 5, wherein said base and vertical wall incorporate a slope that introduces a change in elevation of the two opposing ends.

11. A landscape border edge and retain barrier apparatus comprising member units combined to form a nested bed border barrier apparatus comprising a first fully formed border barrier edging assembly which is the outer assembly and a second fully formed border barrier edging assembly which is the inner assembly, where in said inner assembly in installed inside of the outer assembly in such a manner that the external base of inner assembly overlaps with the internal base of the outer assembly creating a channel between the vertical walls of both assemblies, and providing an external mow over horizontal surface as well as an internal horizontal surface to be covered with any variety of landscape, patio or decking materials.
